(19) United States
(12) Patent Application Publication
(10) Pub. No.: US 2019/0034852 A1
(43) Pub. Date: Jan. 31, 2019

(54) UNIT-BASED LICENSING OF SERVICES

(71) Applicant: Altair Engineering, Inc., Troy, MI (US)

(72) Inventor: James R. Scapa, West Bloomfield, MI (US)

(21) Appl. No.: 16/049,621

(22) Filed: Jul. 30, 2018

Related U.S. Application Data
(60) Provisional application No. 62/538,140, filed on Jul. 28, 2017.

(51) Int. Cl. G06Q 10/06

(52) U.S. Cl. CPC G06Q 10/06315

(57) ABSTRACT

Unit-based licensing of services may include receiving a unit-based licensing service access request message including information indicating a customer account, a requested service, requested utilization temporal data, and requested utilization spatial data. In response to receiving the unit-based licensing service access request message, availability data may be identified for the requested service. On a condition that the availability data indicates an available state corresponding to the requested service, a cardinality of assigned units based on the requested service and a cardinality of available licensing units allocated to the customer account may be determined. A response message may be output, which may include indicating that the request is granted, on a condition that the cardinality of the assigned units is within the cardinality of the available licensing units, or indicating that the request is denied, on a condition that the cardinality of the assigned units exceeds the cardinality of the available licensing units.

### TECHNICAL FIELD

The present disclosure relates to systems and methods for unit-based licensing of services.

### BACKGROUND

Services, such as limited access services, which may include vehicle use, real property use, common or private carrier access, and the like, may be sold or licensed to an end-user customer. For example, the right to access a service may be licensed to a user and a provider or vendor of the service may retain ownership of real or personal property associated with the service. Accordingly, it may be desirable to provide unit-based licensing of services.

### SUMMARY

Disclosed herein are aspects, features, elements, implementations, and embodiments of unit-based licensing for event and digital content access.

In an embodiment, a method of unit-based licensing of services is disclosed. Unit-based licensing of services may include receiving a unit-based licensing service access request message including information indicating a customer account, information indicating a requested service, requested utilization temporal data, and requested utilization spatial data. Unit-based licensing of services may include, in response to receiving the unit-based licensing service access request message, identifying availability data based on the requested service, the requested utilization temporal data, and the requested utilization spatial data. Unit-based licensing of services may include, on a condition that the availability data indicates an available state corresponding to the requested service, the requested utilization temporal data, and the requested utilization spatial data, determining a cardinality of assigned units based on the requested service, the requested utilization temporal data, and the requested utilization spatial data, identifying a cardinality of available licensing units allocated to the customer account, and determining whether the cardinality of the assigned units is within the cardinality of the available licensing units. Unit-based licensing of services may include outputting a response message, which may include indicating that the request is granted, on a condition that the cardinality of the assigned units is within the cardinality of the available licensing units, and indicating that the request is denied, on a condition that the cardinality of the assigned units exceeds the cardinality of the available licensing units.

Variations in these and other aspects, features, elements, implementations, and embodiments of the methods, apparatus, procedures, and algorithms disclosed herein are described in further detail hereafter.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a diagram of an example of a computing and communication system for unit-based licensing of services in accordance with embodiments of this disclosure.

FIG. 2 is a flow diagram of an example of unit-based licensing of services in accordance with embodiments of this disclosure.

### DETAILED DESCRIPTION

A provider or vendor, or an agent thereof, of a service, such as a limited access service, may control access to the service by licensing the service to end users or customers. A limited access service may be a service that includes access to, or use of, a resource, such as a limited availability durable physical resource. The access or use of a limited availability durable physical resource by an end user or customer may exclude other concurrent use or access of the limited availability durable physical resource.

Unit-based licensing of services may include licensing that controls access to a service by allocating licensing units to a customer account, such that one or more licensing units may be redeemed or charged to use or access one or more services in accordance with a defined service access period. For example, a service provider or a licensing manager may receive an electronic communication, such as a unit-based licensing service access request message, which may indicate a requested service and a customer account, the service provider or the licensing manager may determine whether a limited availability durable physical resource associated with the service is available, and the service provider or the licensing manager may charge a number or cardinality of licensing units to the customer account for access to the requested service.

For example, the limited access service may be a private use vehicle service, and the limited availability durable physical resource associated with the requested service may be a vehicle, such as an automobile, a boat, an airplane, or the like. In another example, the limited access service may be a real property use service, and the limited availability durable physical resource associated with the requested service may be real property, such as a hotel room, a house, an office, a room, a parcel of land, or the like. In another example, the limited access service may be a common or private carrier access service, and the limited availability durable physical resource associated with the requested service may be a seat, or other space, on a transportation device of a common or private carrier, such as a seat on an airline, a seat on a bus, a seat on a train, use of a car service, a cabin on a cruise line, or the like.

The aspects, features, elements, and embodiments of methods, procedures, or algorithms disclosed herein, or any part or parts thereof, may be implemented in a computer program, software, or firmware incorporated in a non-transitory computer-readable storage medium for execution by a computer or processor, such as a special purpose computer or processor, and may be implemented as a computer program product, such as a computer program product accessible from a tangible computer-usable or computer-readable medium.

As used herein, the terminology “computer” or “device” includes any unit, or combination of units, capable of performing any method, or any portion or portions thereof, disclosed herein. Devices may further include mobile devices that may include user equipment, a wireless transmit/receive unit, a mobile station, a fixed or mobile subscriber unit, a pager, a cellular telephone, a personal digital assistant (PDA), a computer, or any other type of user device capable of operating in a mobile environment.

As used herein, the terminology “processor” includes a single processor or multiple processors, such one or more special purpose processors, one or more digital signal processors, one or more microprocessors, one or more controllers, one or more microcontrollers, one or more Application Specific Integrated Circuits (ASICs), one or more Application Specific Standard Products (ASSPs); one or more Field Programmable Gate Arrays (FPGAs) circuits, any other type or combination of integrated circuits (ICs), one or more state machines, or any combination thereof.

As used herein, the terminology “memory” includes any computer-usable or computer-readable medium or device that can, for example, tangibly contain, store, communicate, or transport any signal or information for use by or in connection with any processor. Examples of computer-readable storage mediums may include one or more read-only memories, one or more random access memories, one or more registers, one or more cache memories, one or more semiconductor memory devices, one or more magnetic media, such as internal hard disks and removable disks, one or more magneto-optical media, one or more optical media such as a Compact Disk Read-Only Memory (CD-ROM), and digital versatile disks (DVDs), or any combination thereof.

As used herein, the terminology “example”, “embodiment”, “implementation”, “aspect”, “feature”, or “element” indicate serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify”, or any variations thereof, includes selecting, ascertaining, computing, looking up, receiving, determining, establishing, obtaining, or otherwise identifying or determining in any manner whatsoever using one or more of the devices shown and described herein. As used herein, the terminology “cardinality” includes a number or count of elements or items in a set, group, plurality, or any other collection of zero or more elements.

As used herein, the terminology “or” is intended to mean an inclusive “or” rather than an exclusive “or”. That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terminology “limited access service,” or variations thereof, may include a service that includes access to, or use of, a resource, such as a limited availability durable physical resource.

Unit-based licensing of services may include licensing that controls access to a service by allocating licensing units to a customer account, such that one or more licensing units may be redeemed or charged to use or access one or more services in accordance with a defined service access period. The access or use of a limited availability durable physical resource by an end user or customer may exclude other concurrent use or access of the limited availability durable physical resource.

As used herein, the terminology “assigned license units”, “price”, “licensing price” or variations thereof, may include an assigned number of licensing units that may be exchanged or redeemed to use or access a particular service.

As used herein, the terminology “licensed units” or “allocated units” may refer to a total number of units provided to a customer or customer group. As used herein, the terminology “checked out units”, “redeemed units”, or “exchanged units” may refer to assigned license units charged to a customer for the use of or access to a particular service. “Available units” may refer to a difference between licensed units and checked out units. In some embodiments, licensing units may be temporarily or permanently exchanged for the use of or access to a particular service. Temporarily exchanged licensing units may be returned to the pool of available units associated with the customer upon termination or completion of the use of or access to a particular service. Returned units may be included in the available units allocated to the customer and may be redeemed for the use of or access to a particular service.

As used herein, the terminology “access” or “accessing” may include taking possession of, obtaining, retrieving, receiving, using, or otherwise utilizing or accessing a service or one or more limited availability durable physical resources associated with the service.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

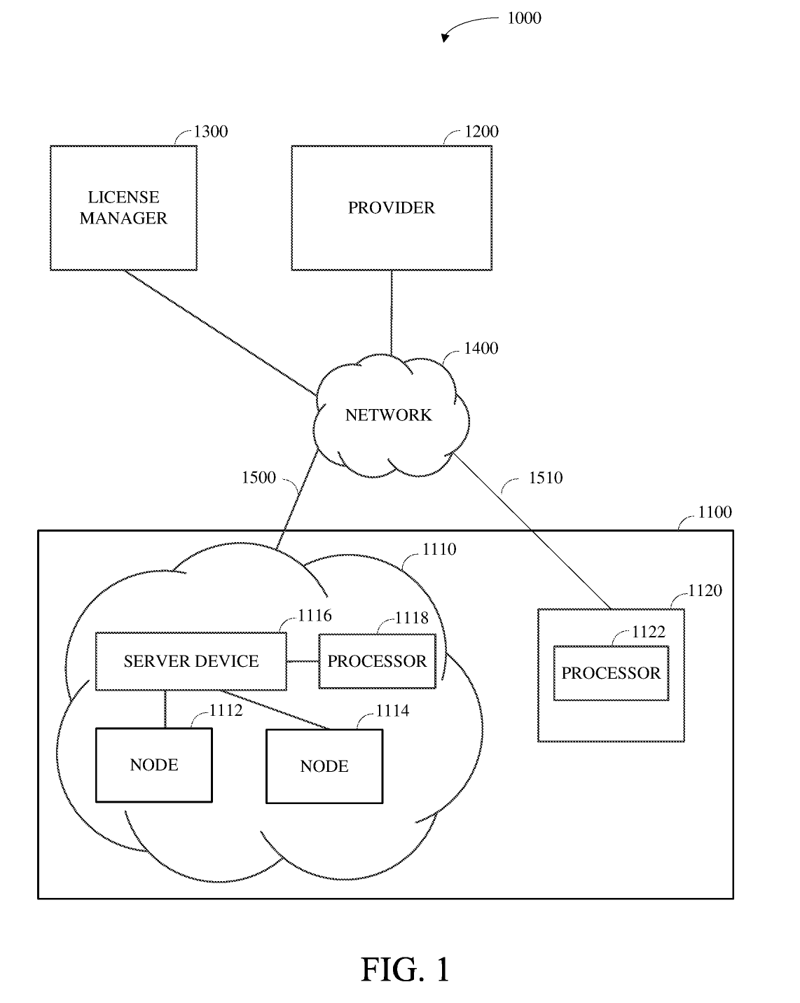

FIG. 1 is a diagram of an example of an electronic computing and communication system 1000 for unit-based licensing of services in accordance with embodiments of this disclosure. For simplicity, the electronic computing and communication system 1000 shown in FIG. 1 includes a customer system 1100, a provider system 1200, a license manager 1300, and an electronic communication network 1400; however, other elements, such as multiple networks, access points, or communication mediums may be included in the electronic computing and communication system 1000 for unit-based licensing of services.

The customer system 1100 may include a customer electronic communication network 1110. Although one customer electronic communication network 1110 is shown in FIG. 1 for simplicity, the customer system 1100 may include any number of customer electronic communication networks, which may include a hierarchy of customer electronic communication networks.

The customer electronic communication network 1110 may include nodes 1112, 1114, a server device 1116, a processor 1118, or any combination thereof. Although two nodes 1112, 1114, one server device 1116, and one processor 1118 are shown in FIG. 1 for simplicity, other configurations of the customer electronic communication network 1110 may be used. For example, the customer electronic communication network 1110 may include multiple server devices or the customer electronic communication network 1110 may omit the processor 1118. Although the nodes 1112, 1114 are shown as being connected to the server device 1116 in a spoke configuration, the nodes 1112, 1114 may be connected to the server device 1116 in any other electronic computer network configuration or the server device 1116 may be omitted from the customer electronic communication network 1110. Although shown as separate units, in some embodiments, one or more elements of the customer electronic communication network 1110, such as the server device 1116 and the processor 1118, may be implemented as a combined device.

A node 1112, 1114 may be a device, such as a computer, and may manage access to services provided by the provider 120. For example, a node 1112, 1114 may manage access to services in response to user input. A node 1112, 1114 may be connected to the server device 1116 and may have a unique network address. A node 1112, 1114 may communicate with the other nodes 1112, 1114 within the customer electronic communication network 1110. The server device 1116 may communicate with the processor 1118.

The customer system 1100 may include a customer device 1120, such as a computer or mobile device, which may include a processor 1122, and which may operate separately from the customer electronic communication network 1110. Although one customer device 1120 is shown in FIG. 1 for simplicity, the customer system 1100 may include any number of customer devices.

Elements of the customer system 1100, such as elements of the customer electronic communication network 1110 and the customer device 1120, may communicate with each other or with elements external to the customer system 1100, such as the provider 1200. For example, elements of the customer electronic communication network 1110 and the customer device 1120 may independently communicate through the electronic communication network 1400.

In some embodiments, the customer system 1100 may be associated with an individual user or customer, or to an account representing the individual user or customer, and the individual user or customer may access services using the allocated licensing units. In some embodiments, the customer system 1100 may comprise devices and networks through which the individual user or customer may manage access to services provided by the provider 1200.

In some embodiments, the customer system 1100 may be associated with a collection or group of customers, or members, and shared licensing units may be allocated to the group. For example, a group may include one or more families, a classroom of students, a small business, a social group, or any other organization capable of licensing services such that members of the group are capable of accessing or using the services. In some embodiments, some or all of the shared licensing units allocated to a group may be allocated to a defined sub-group.

The provider 1200 may be a device or system configured to receive and manage requests for one or more services. For example, the provider 1200 may include an Internet Protocol (IP) network-based unit, such as a website service, that implements methods for providing access to services to a customer.

The provider 1200 may provide the customer system 1100, or an element thereof, with information associated with accessing a service requested by, or via, the customer system 1100, which may include information indicating to the customer system 1100 that a request for access to a service is granted or denied. Although FIG. 1 shows a single provider 1200 as a single unit, the provider 1200 may include any number of discrete units and any number of providers 1200 may be used.

In some embodiments, the license manager 1300 may control the access to service provided by provider 1200. Although shown as a separate unit, in some embodiments, the license manager 1300 may be incorporated with provider 1200, the customer system 1100, or both. In some embodiments, the license manager 1300 may monitor usage of services licensed to a customer associated with the customer system 1100. For example, the license manager 1300 may detect the termination or conclusion of a defined service access period associated with accessing a service by the customer.

The license manager 1300 may generate and maintain a log. The log may include a record of a number of available units that may be used by the customer system 1100 at any given time. In some embodiments, the license manager 1300 may update the log for each change of the available units for customer system 1100. For example, the log may be updated to indicate a change in the available units in response to the customer being licensed a service from the provider 1200, the termination of a defined service access period associated with a service licensed to the customer, or the like. In some embodiments, the log may be a file, or database, stored in a memory in communication with provider 1200, the license manager 1300, or both.

In some implementations, unit-based licensing of services may include communication between the customer system 1100, the provider 1200, the license manager 1300, or any combination thereof, via the electronic communication network 1400.

The electronic communication network 1400 may be a local area network (LAN), wide area network (WAN), virtual private network (VPN), a mobile or cellular telephone network, the Internet, or any other electronic communication medium. Although not expressly shown in FIG. 1, the customer system 1100, provider 1200, the license manager 1300, or any combination thereof, may communicate with the electronic communication network 1400 through one or more Internet service providers (ISPs). In some embodiments, the customer electronic communication network 1110, the customer device 1120, or both, may communicate with the electronic communication network 1400 via one or more communication links 1500, 1510, which may include one or more wired or wireless connections.

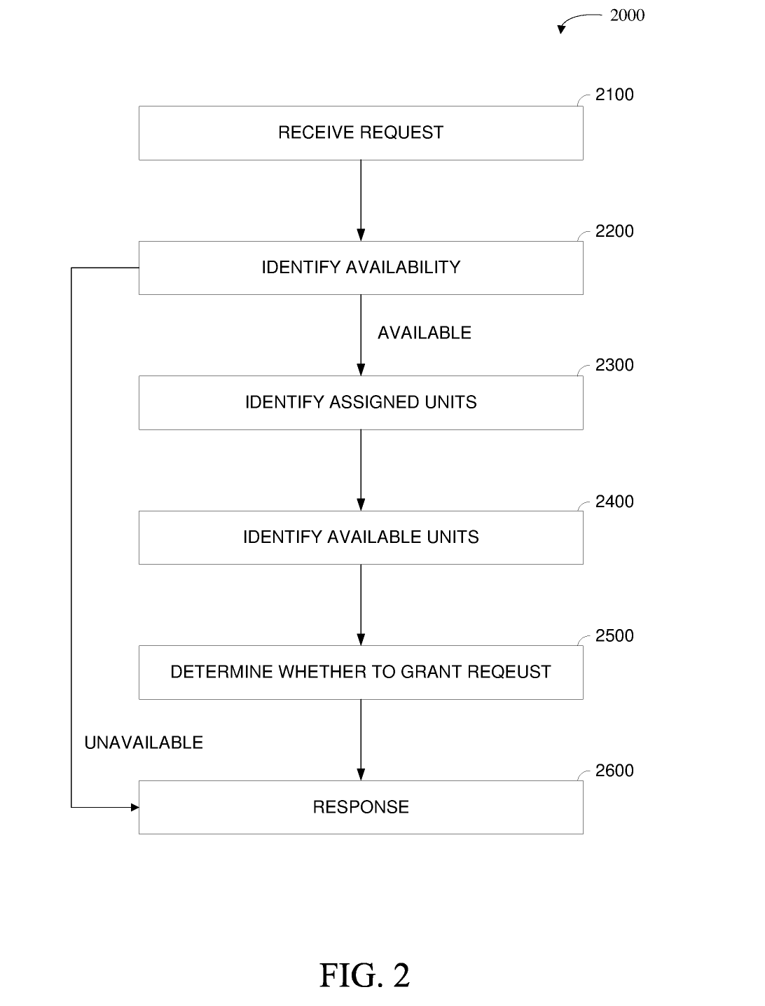

FIG. 2 is a flow diagram of an example of unit-based licensing of services 2000 in accordance with embodiments of this disclosure. Unit-based licensing of services 2000, or a portion thereof, may be implemented in a device, such as the customer device 1120 shown in FIG. 1, the server device 1116 shown in FIG. 1, or a combination thereof, which may include electronic communication, such as communication via a communication system, such as the network 1400 shown in FIG. 1, or any other wired or wireless computer communication system or network.

Unit-based licensing of services 2000 may include receiving a unit-based licensing service access request message at 2100, identifying availability data at 2200, determining a cardinality of assigned license units based on the availability data at 2300, identifying a cardinality of available licensing units at 2400, determining whether the cardinality of the assigned license units is within the cardinality of the available licensing units at 2500, outputting a response message at 2600, or a combination thereof.

A unit-based licensing service access request message may be received at 2100. For example, the unit-based licensing service access request message may be received at a server device from a customer device via electronic communication, such as in response to user input at the customer device.

The unit-based licensing service access request message may include information indicating a customer account. For example, the unit-based licensing service access request message may include a unique customer account identifier. In some embodiments, the unit-based licensing service access request message may include other information, such as an IP address, or a portion thereof, of a customer device or another element of a customer system, and receiving the unit-based licensing service access request message at 2100 may include identifying the customer account based on the IP address, such as by looking up a customer account identifier associated with the IP address from a data source, such as a database.

The unit-based licensing service access request message may include information indicating a requested service, which may be a limited access service. A limited access service may be a service that includes access to, or use of, a resource, such as a limited availability durable physical resource, by an end user or customer. The access or use of a limited availability durable physical resource by an end user or customer may exclude other concurrent use or access of the limited availability durable physical resource.

For example, the limited access service may be a private use vehicle service, which may include access to, or use of, a vehicle, such as an automobile. In some embodiments, the information indicating a requested service may indicate a vehicle type, such as automobile, boat, airplane, or any other type of vehicle. In some embodiments, the information indicating a requested service may indicate a vehicle class. For example, the vehicle type may be automobile, and the vehicle class may be compact, full size, luxury, or any other class of automobile.

In some embodiments, the information indicating a requested service may indicate other information defining or describing the requested service, or the limited availability durable physical resource associated with the requested service. For example, the limited access service may be a private use vehicle service, and the information indicating a requested service may indicate a vehicle type, a vehicle make, a vehicle model, or any other distinctly identifiable information defining or describing the requested service, or the limited availability durable physical resource associated with the requested service. In another example, the information indicating a requested service may indicate a review or rating threshold or range, such as a minimum rating, a required feature, or the like.

In another example, the limited access service may be a real property use service, which may include access to, or use of, real property, such as a hotel room. In some embodiments, the information indicating a requested service may indicate a type of real property, such as a hotel room, a house, a parcel of land, or the like.

In another example, the limited access service may be a common or private carrier access service, which may include access to, or use of, a common or private carrier, such as passage on an airline, a bus, a train, a car service, a cruise line, or the like. In some embodiments, the information indicating a requested service may indicate a type of common or private carrier, such as an airline, a bus line, a train line, a car service, a cruise line, or the like. In some embodiments, the information indicating a requested service may indicate a class of carriage, such as first class, economy class, business class, or any other class of carriage.

The unit-based licensing service access request message may include requested utilization temporal data. The requested utilization temporal data may indicate expected utilization start temporal data, such as an expected utilization start date, time, or both. The requested utilization temporal data may indicate expected utilization end temporal data, such as an expected utilization end date, time, or both. The requested utilization temporal data may indicate an expected temporal utilization period, which may include expected utilization start temporal data, expected utilization end temporal data, or both.

For example, the limited access service may be a private use vehicle service, and the requested utilization temporal data may indicate an expected temporal utilization period, which may include expected utilization start temporal data and expected utilization end temporal data. The expected utilization start temporal data may indicate a temporal location, such as a date, or a date and time, and a defined vehicle associated with the service access request may be inaccessible by the customer temporally prior to the temporal location indicated by the expected utilization start temporal data and may be exclusively accessible by the customer temporally concurrent with and subsequent to temporal location indicated by the expected utilization start temporal data. The expected utilization end temporal data may indicate a temporal location, such as a date, or a date and time, and the defined vehicle associated with the service access request may be exclusively accessible by the customer temporally concurrent with and prior to temporal location indicated by the expected utilization end temporal data and may be inaccessible by the customer temporally subsequent to the temporal location indicated by the expected utilization end temporal data.

In another example, the limited access service may be a real property use service, and the requested utilization temporal data may indicate an expected check-in date, an expected check-out date, or both.

In another example, the limited access service may be a common or private carrier access service, and the requested utilization temporal data may indicate an expected date, or date and time, of service.

The unit-based licensing service access request message may include requested utilization spatial data. The requested utilization spatial data may indicate a geographic location associated with accessing or using the service.

For example, the limited access service may be a private use vehicle service, and the requested utilization spatial data may indicate a vehicle pick-up location, a vehicle drop-off location, or both.

In another example, the limited access service may be a real property use service, and the requested utilization spatial data may indicate a location of the corresponding real property.

In another example, the limited access service may be a common or private carrier access service, and the requested utilization spatial data may indicate an origin, a destination, or both.

A provider or vendor, or an agent thereof, of a service, such as a limited access service that includes access to, or use of, a resource, such as a limited availability durable physical resource, may own, rent, lease, or may otherwise control access to a resource owned, or otherwise controlled, by a third-party owner. For example, a vehicle owner may provide access to or use of a vehicle to the service provider, and the service provider may control access to a limited access service associated with the vehicle by licensing the service to end users or customers and providing access to, or use of, the vehicle by the customer. In some embodiments, the third party recourse owner may receive consideration from the provider for the use of or access to the resource.

Availability data may be identified at 2200. Identifying the availability data at 2200 may include determining an expected availability, such as a probability of availability, for a limited availability durable physical resource associated with the service requested at 2100 corresponding to the requested utilization temporal data, the requested utilization spatial data, or both. For example, a computing and communication device, such as a server, of a provider of the service, such as the provider 1200 shown in FIG. 1, or a license manager, such as the license manager 1300 shown in FIG. 1, may receive the unit-based licensing service access request message at 2100 and may determine the expected availability by searching, or otherwise evaluating, a data source, such as a database, based on the requested service, the requested utilization temporal data, and the requested utilization spatial data.

Identifying the availability data at 2200 may include identifying an availability state corresponding to the requested service, which may be based on the requested utilization temporal data, the requested utilization spatial data, or both. For example, the expected availability may be at least, such as equal to or greater than, a minimum expected availability threshold, which may indicate that the requested service is available, and the availability state may be identified as available, or the expected availability may be less than the minimum expected availability threshold, which may indicate that the requested service is unavailable, and the availability state may be identified as unavailable.

In some embodiments, availability data identified at 2200 may indicate that the expected availability is at least, such as equal to or greater than, a minimum expected availability threshold, which may indicate that the requested service is available, and a cardinality, such as a number or count, of assigned license units for accessing or using the service may be identified at 2300. For example, a license manager, such as the license manager 1300 shown in FIG. 1, may identify the assigned license units for the requested service. Identifying the assigned license units at 2300 may include identifying the assigned license units based on the availability data, the customer, or a customer account associated with the customer, the requested service, the requested utilization temporal data, and the requested utilization spatial data, or a combination thereof.

A cardinality, such as a number or count, of available units associated with the customer, or a customer account associated with the customer, may be determined at 2400. The available units may indicate a number or count of licensing units that may be used by the customer system at a given time, such as at the time the request is received or the temporal location indicated by the requested utilization temporal data. For example, although not shown in FIG. 2, one or more licensing units may be allocated to the customer system, one or more of the allocated units may be temporarily or permanently exchanged or checked out for access to one or more services, and the number of available units may indicate the difference between the number of allocated units and the number of checked out units.

Whether to grant access may be determined at 2500. Determining whether to grant access at 2500 may include determining whether the cardinality of the assigned license units is within the cardinality of the available licensing units. For example, determining whether to grant access at 2500 may be based on the cardinality of available units identified at 2400, the cardinality of assigned license units identified at 2300, or a combination thereof.

Determining whether to grant access at 2500 may include determining whether the cardinality of available units is at least, such as equal to or greater than, the cardinality of assigned license units. In some embodiments, determining whether to grant access at 2500 may include determining the cardinality of available licensing units allocated to the customer system to charge against the customer system for access to the requested service. The provider or the licensing manager may determine the cardinality of checked out units currently charged against the customer system, and may determine a cardinality of licensing units to charge against the customer system based on a difference between the cardinality of assigned license units and the cardinality of currently checked out units for the customer system. For example, the cardinality of currently checked out units for the customer system may be greater than the cardinality of assigned license units, the request may be granted and the cardinality of units to charge against the customer system may be zero. In another example, the cardinality of currently checked out units for the customer system may be less than the cardinality of assigned license units, the request may be granted, and the cardinality of units to charge against the customer system may be equal to the difference between the cardinality of assigned license units and the cardinality of currently checked out units.

A response may be output at 2600. For example, the provider or licensing manager may generate a response indicating that the request for access is granted or denied and may transmit the response to the customer system.

The availability data identified at 2200 may indicate that the expected availability is at least, such as equal to or greater than, the minimum expected availability threshold, which may indicate that the requested service is available, the number of available units associated with the customer may be at least, such as equal to or greater than, the number of assigned license units, the request may be granted, and outputting the response at 2600 may include outputting a response indicating that the request is granted.

In some embodiments, the request for access may be denied. For example, the number of available units associated with the customer may be less than the number of assigned license units and the request may be denied. In some embodiments, the provider may reject the request and may prevent the customer system from accessing the requested service.

Although not shown separately in FIG. 2, the cardinality of available licensing units allocated to the customer system may be charged to the customer system. For example, the availability data identified at 2200 may indicate that the expected availability is at least, such as equal to or greater than, the minimum expected availability threshold, which may indicate that the requested service is available, the number of available units associated with the customer may be at least, such as equal to or greater than, the number of assigned license units, the request may be granted, and the cardinality of available licensing units allocated to the customer system may be charged to the customer system. In some embodiments, the customer system may be charged in response to granting the request for access at 2600. In some embodiments, the customer system may be charged in response to accessing or using the requested service (not shown).

In some embodiments, charging the customer system may include recording the cardinality of licensing units charged, updating the cardinality available units associated with the customer system, or both. In some embodiments, the license manager or provider may record any change in charged units or available units in a log. In some embodiments, the cardinality of available units for the customer system may be decreased in an amount equal to the cardinality of assigned license units for accessing or using the service indicated in the request.

In some embodiments, availability data identified at 2200 may indicate that the expected availability is less than the minimum expected availability threshold, which may indicate that the requested service is unavailable, determining the cardinality of assigned license units based on the availability data at 2300, identifying the cardinality of available licensing units at 2400, and determining whether the cardinality of the assigned license units is within the cardinality of the available licensing units at 2500 may be omitted, and outputting the response at 2600 may include outputting a response indicating that the requested service is unavailable.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

1. A method comprising:
receiving, at a first computer system from a second computer system, a unit-based licensing service access request message, the unit-based licensing service access request message including:
information indicating a customer account;
information indicating a requested service;
requested utilization temporal data; and
requested utilization spatial data;
in response to receiving the unit-based licensing service access request message, identifying, by the first computer system, availability data based on the requested service, the requested utilization temporal data, and the requested utilization spatial data;
on a condition that the availability data indicates an available state corresponding to the requested service, the requested utilization temporal data, and the requested utilization spatial data:
determining, by the first computer system, a cardinality of assigned units based on the requested service, the requested utilization temporal data, and the requested utilization spatial data;
identifying, by the first computer system, a cardinality of available licensing units allocated to the customer account; and
determining, by the first computer system, whether the cardinality of the assigned units is within the cardinality of the available licensing units; and
outputting, by the first computer system, a response message, wherein outputting the response message includes:
indicating that the request is granted, on a condition that the cardinality of the assigned units is within the cardinality of the available licensing units; and
indicating that the request is denied, on a condition that the cardinality of the assigned units exceeds the cardinality of the available licensing units.

2. The method of claim 1, wherein the requested service is a private use vehicle service.

3. The method of claim 2, wherein the information indicating the requested services comprises at least one of an indication of a vehicle type, an indication a vehicle class, an indication of a vehicle model, or an indication of a vehicle make.

4. The method of claim 3, wherein the indication of the vehicle type is one of an automobile, a boat, or an airplane.

5. The method of claim 3, wherein the indication of a vehicle class is one of a compact class, a full size class, or a luxury class.

6. The method of claim 1, wherein the requested utilization temporal data comprises at least one of an indication of an expected utilization start date or an indication of an expected utilization start time.

7. The method of claim 1, wherein the requested utilization spatial data comprises at least one of an indication of a vehicle pick-up location or an indication of a vehicle drop-off location.

8. The method of claim 1, wherein identifying the availability data comprises:
determining an expected availability of the requested service corresponding to the request utilization data and the requested utilization spatial data.

9. The method of claim 8, wherein determining the expected availability comprises determining a probability of availability of the requested service.

10. The method of claim 8, wherein determining the expected availability of the requested service comprises determining that the expected availability is greater than or equal to a minimum expected availability threshold, and
responsive to determining that the expected availability is greater than or equal to the minimum expected availability threshold, identifying the available state as available.

11. The method of claim 1, wherein the requested service is a real property use service.

12. The method of claim 1, wherein the requested service is a common carrier access service.

13. The method of claim 1, wherein the requested service is a private carrier access service.

14. The method of claim 1, wherein the first computer system is communicatively coupled to the second computer system through a communications network.
